(19) United States
(12) Patent Application Publication
(10) Pub. No.: US 2024/0053011 A1
(43) Pub. Date: Feb. 15, 2024

(54) GUIDING ARRAY

(71) Applicant: Reaction Engines Limited, Abingdon, Oxfordshire (GB)

(72) Inventor: Ignacio Duran, Abingdon (GB)

(73) Assignee: Reaction Engines Limited, Abingdon, Oxfordshire (GB)

(21) Appl. No.: 18/035,803

(22) PCT Filed: Nov. 9, 2021
(86) PCT No.: PCT/EP2021/081039

§ 371 Date: May 8, 2023

(30) Foreign Application Priority Data
Nov. 10, 2020 (GB) 2017691.3

(51) Int. Cl. F23R 3/02; F01D 25/08; F01D 5/14

(52) U.S. Cl. CPC F23R 3/02; F01D 25/08; F01D 5/141

(57) ABSTRACT

A guiding array (200; 600) for a flow duct system (100; 200; 300; 500) includes a series of internested annular guide vanes (202), leading edges (230) or other common parts of the guide vanes being arranged to be positioned different distances from an upstream port, which may be an imaginary cylindrical surface substantially at a heat exchanger outlet (308; 508) within a fluid handling system such as an engine module (38).

The present invention relates to a guiding array such as of the type which may be used in ducting systems, for example duct systems for engines, such as for aerospace, industrial or other applications, and to, industrial equipment, aircraft or flying machines including such engines such as for propulsion thereof.

### BACKGROUND

WO2015/052469 discloses a duct system with an array of guide vanes which are arranged near a downstream outlet from a radial flow heat exchanger. Whilst this prior art disclosure is a great advance on what went before it and is eminently suitable for a number of operational situations, for some applications such as aerospace, e.g. for launch into orbit or fast hypersonic cruise, performance needs further improvement.

One object of the present disclosure is to alleviate at least to a certain extent the problems of the prior art. An alternative object is to provide a useful guiding array.

### SUMMARY

According to the present disclosure there is provided a guiding array for turning flow in a fluid handling system, the guiding array comprising a plurality of guide vanes, common parts of the guide vanes being arranged to be positioned different distances from an upstream port within a fluid handling system.

Advantageously this has been found to facilitate duct flow with a more uniform flow downstream of the guiding array and to avoid the disturbance of flow upstream as well. In particular, upstream, across the flow, static pressure and/or flow speed and direction may be significantly more uniform that in prior art arrangements: for example, when flow upstream of the guiding array is with a radial or substantially radial flowpath and when a heat exchanger is located in this flowpath flow both downstream and upstream of the heat exchanger can be kept more uniform than in the prior art. This has the advantage that across the heat exchanger (i.e. in an axial direction) on its hot side, for example when the heat exchanger is cooling air heading towards the guiding array, substantially all of the heat exchanger (in the axial sense at its hot inlet) can operate at near its maximum operating status temperature. Advantageously, the guiding array therefore enables a duct system including a heat exchanger and the guiding array to provide more uniform downstream flow as well as more uniform inlet and outlet temperatures of the heat exchanger when it is located upstream of the guiding array, thereby ultimately allowing further weight minimisation in the heat exchanger for a given level of performance (heat exchange) and thus greater flight payload.

The guiding array may be arranged to be positioned within a duct system for turning flow from one of substantially radial and substantially axial to the other of substantially radial and substantially axial.

The guiding array may be arranged to be positioned within a duct system for turning flow from substantially radially inward to substantially axial.

At least one vane of the array may comprise a circular or substantially circular ring.

Each vane may comprise a circular or substantially circular ring, the vanes being concentric about a central longitudinal axis of the array.

The vanes may be arranged with larger, optionally progressively larger, cross-dimension (or diameter) towards one end of the array. This end may be an end of the array in an axial sense.

The guiding array may be for turning flow at a flow bend from substantially radially inward flow to substantially axial flow downstream of the array, the end of the array having a vane with a larger cross-dimension (or diameter) being arranged for positioning adjacent an inner side of the flow bend, an end of the array having a vane with a smaller dimension being arranged for positioning at an outer side of the flow bend.

The common parts of the vanes may be leading edges of the vanes. Alternatively, the common parts may be trailing edges, mid-cord regions thereof, or other parts.

The leading edges (or other common parts) may arranged at points in space that are located on an imaginary conic surface. Thus, in a section through the array in a plane coincident with a central longitudinal axis of the array, the common parts at one cut through each vane (the skilled person will appreciate that there will be two such cuts through a whole circular ring-like vane) may be regularly spaced in a diagonal formation.

The use of a diagonal formation has been found to significantly improve uniformity of flow especially downstream of the guiding array.

Alternatively, the leading edges (or other common parts) may be arranged at points in space that are located (a) irregularly spaced apart from one another in the radial and/or axial directions relative to a central longitudinal axis of the array and/or (b) on an imaginary parabolic surface of revolution around a central longitudinal axis of the array. Highly surprisingly, the use of parabolic positioning has been discovered in numerical flow analysis to result in very significant unexpected flow improvement compared to each of the prior art and diagonal arrays. For example, when a diagonal array is used at a bend from radial to axial flow downstream, the flow upstream of the array is seen to smoothly flow round long arcs towards and then through between the leading edges of the vanes continuing in long turning arcs downstream, likely causing significantly more flow to pass between some vanes than others and thus making flow upstream and downstream of the array still somewhat non-uniform. But when an irregular and/or parabolically located array is used, it has amazingly been seen that the upstream flow stays radial (NB: it would be axial in the case of axial upstream flow) until very close indeed to the leading edges of all of the vanes substantially all of the flow turn happens between the vanes and the flow from very close indeed to the trailing edges of the vanes is substantially axial. While the diagonal array is in some respects an improvement over the prior art, the irregular and/or parabolically positioned array can provide phenomenal improvements over both of the diagonal and prior art arrays. As will be seen below, to look at, the diagonal and parabolically positioned arrays of the embodiments of this disclosure both look very different to the prior art and very similar to each other: it is most highly surprising that the apparently small differences in configuration between the diagonal and parabolic arrangements have in fact allowed the latter to have huge advantages over the former in the uniformity of flow both downstream and upstream of the array. After much thought by the present inventors, it has been calculated that all of the prior art arrangement, the improved diagonal arrangement and the much improved parabolic arrangement can be configured with the inlet to outlet ratio between each pair of adjacent vanes manufactured equal, but the parabolic arrangement can also enable the mass flow rate between each pair of adjacent vanes to be substantially equal to that between the other vanes. The generally equalising of the mass flow rates in turn encourages flow upstream of the array not to turn until it is at the array. Thus with radial flow upstream of the array, static pressure (and temperature) considered along an axial direction upstream of the array, such as at a radial flow heat exchanger, can be very much more uniform than a diagonal array, as well as than the prior art array.

In one example, the parabolic surface of revolution may be

$$\frac{r ( x )}{R} = \sqrt{\frac{x}{L}}$$

where r(x) is the radial location of the leading edge of the guide vane, as a function of its axial coordinate x, R is the radius of an axial flow duct into or from which the array communicates, and is an axial length of a radial flow duct from or into which the array communicates.

The vanes in the array may be configured generally in a skep beehive-shaped fashion.

Each vane, in a cross section thereof by a plane coincident with a central longitudinal axis of the array, may include a curved region between a leading edge and a trailing edge thereof. In some examples, leading portions of the vanes near the leading edges may thus not be parallel to trailing portions of the vanes near the trailing edges. This may assist in turning flow, while also avoiding flow stall/significant boundary layer detachment downstream of the leading edges.

Each said cross section of each vane may be substantially identical to the said cross section of another vane or all vanes in the array.

Other than any streamlining curvature at a leading edge and/or a trailing edge thereof, a vane as a substantially constant thickness between a leading edge and a trailing edge thereof. This may advantageously allow the vanes to be made from inexpensive sheet material which is suitably worked into shape; however, in some embodiments, vane thickness may vary along the chord thereof, for example increasing downstream of the leading edge, then decreasing again before the trailing edge.

Vanes of the array may be internested with one another, at least in a sense that in a section taken perpendicular to a central longitudinal axis of the array a leading or trailing edge of one vane is overlapped with an adjacent vane.

Each vane may have a leading edge and a trailing edge, and a ratio I₁₋₂/O₁₋₂ (between an inlet area I₁₋₂ defined between the leading edges of a first and a second adjacent vane and an outlet area O₁₋₂ defined between the training edges of the first and the second vane) may be equal or substantially equal to the ratio I₂₋₃/O₂₋₃ (between an inlet area I₁₋₂ defined between the leading edges of the second and a third adjacent vane and an outlet area O₁₋₂ defined between the training edges of the second and the third vane.

The ratio I₁₋₂/O₁₋₂ may be equal or substantially equal the equivalent ratio Iₙ₋₍ₙ₊₁₎/Oₙ₋₍ₙ₊₁₎ between any adjacent two vanes in the array.

The upstream port may be defined by an imaginary cylindrical surface in space.

In a further aspect of the present disclosure there is provided a ducting system including a first duct portion arranged to carry a substantially radial flow communicating via a bend with a second adjacent duct portion arranged to carry a substantially axial flow, a guiding array as set out in the earlier aspect hereof being located in the region of the bend for turning flow passing between the duct portions.

The first duct portion may be located in a location upstream (in use) of the second duct portion.

The first duct portion may contain a heat exchanger, the heat exchanger being adapted to receive substantially radial flow from within the first duct portion into an inlet of the heat exchanger and to provide a substantially radial flow, optionally with also at least a swirl component, back into the first duct portion from an outlet from the heat exchanger.

The heat exchanger in one embodiment may be adapted to handle air flowing through the duct system and past the ducting array. A second flow path for coolant such as helium may be provided through the heat exchanger.

The outlet from the heat exchanger may be substantially at an imaginary cylindrical surface in space which coincides with the upstream port for the guiding array.

The first duct portion may be configured in materials arranged to operate continuously handling air with a static temperature of at least 900 degrees C.

The second duct portion may have a substantially cylindrical outer wall portion. The second duct portion may in that case be hollow/empty for axial flow with no central flow guide for at least an axial portion thereof downstream of the guiding array. It is envisaged that in some cases an axially extending flow guide may be used (as shown in WO2015052469) in which case flow at such flow guide will not be truly axial near this flow guide.

The ducting system may include a substantially circular substantially flat end plate portion perpendicular to and concentric with a central longitudinal axis of the guiding array, the end plate forming an extension to a radial wall defining the first duct portion as well as facing the second duct portion.

The ducting system may be used in aerospace, industrial or other applications.

A further aspect of the present disclosure provides an engine including a ducting system as set out in the previous aspect of this disclosure.

The engine may be adapted to combust materials for vehicle propulsion; alternatively the engine may be adapted for static operation, for example in industrial applications.

A further aspect of the disclosure provides a flying machine which includes at least one engine as set out in the previous aspect of this disclosure. Such a flying machine may comprise an aircraft, such as for high speed hypersonic travel, or a spacecraft such as for placing satellites into orbit.

A number of preferred additional aspects of the disclosure and optional features which can apply to the above aspects will now be described.

Another aspect provides a guiding array for a fluid handling unit comprising a plurality of guide vanes for turning flow, wherein the plurality of guide vanes are spaced varying distances apart.

A leading edge (of a vane) facing radial (or axial) oncoming flow of each guide may be arranged at an angle of about 5 to 20 degrees relative to radial (or axial).

A trailing edge (of a vane) facing axial (or radial) flow downstream may be arranged at an angle of about −10 to 10 (or about −5 to 5) degrees to axial (or radial).

Each guide vane may have a rounded leading edge.

Each guide vane may have a rounded trailing edge.

Alternatively a vane may have a sharp leading and/or trailing edge.

Each guide vane may include an arcuate portion between a leading and a trailing edge thereof.

Each guide vane may have a thickness or maximum thickness of thickness of 0.5 to 5 mm. Each guide vane may be of substantially constant or varying thickness from leading edge to trailing edge thereof. The mean thickness of one guide vane may equal or differ from that of at least one other guide vane.

A support structure may be provided for fixing the guide vanes in position relative to one another.

Each guide vane may be static, without moving appreciably in response to flow.

Guide vanes in the array may have substantially equal chord lengths as one another or differing chord lengths.

At least one guide vane may be made by additive or metal additive manufacturing. Each guide vane may, for example, be formed of steel such as stainless steel, or of other suitable materials, such composites, polymer(s) or plastics, or of a superalloy, which may be coated, for example a Ni, Co or Fe-based superalloy, optionally including Cr or Mo.

A further aspect of the disclosure provides a computer-readable medium having data stored thereon representative of a guiding array according to the disclosure hereof, the data being relayable to an additive manufacturing device to enable the additive manufacturing device to fabricate the guiding array based on the data.

A further aspect of the present disclosure provides a method of manufacturing the ducting array of a previous aspect hereof including forming a said vane thereof by additive manufacturing.

The method may include receiving data from the computer readable medium of a prior aspect hereof.

The method may include translating the data into instructions data for an additive printer to execute.

### BRIEF DESCRIPTION OF THE DRAWINGS

The present invention may be carried out in various ways and one preferred embodiment of a guiding array, a duct system, an engine, and an aircraft in accordance with the present invention will now be described by way of example only, in a non-limiting way with reference to the accompanying drawings, in which:

FIG. 1A is a side elevation of one preferred embodiment of an aircraft incorporating an engine with a guiding array in accordance with a preferred embodiment of the present invention;

FIG. 1B is a top plan view of the aircraft of FIG. 1A using a preferred guiding array and duct system;

FIG. 1C is a rear elevation of the aircraft of FIG. 1A;

FIG. 2 shows a schematic cross-sectional view of a preferred flow duct system used with or in an engine of the aircraft;

FIG. 3 is a view similar to FIG. 2 of the duct system;

FIG. 4A is an isometric view of a preferred guiding array used in the duct system;

FIG. 4B is a side view of the guiding array of FIG. 4A;

FIG. 4C is a bottom plan view of the guiding array of FIG. 4A;

FIG. 5 is a detailed view of detail [a] in FIG. 4B showing part of a flight tube turning vane support of the guiding array;

FIG. 6A is an isometric view of flight tube turning vane steps of the guiding array;

FIG. 6B is a front elevational view of the flight tube turning vane steps of FIG. 6A;

FIG. 6C is a side plan view of the flight tube turning vane steps of FIG. 6A;

FIG. 7 shows a perspective cutaway view of the duct system including the guiding array;

FIG. 8 shows a schematic cross-sectional view of part of the duct system of FIG. 7, including streamlines indicting the direction of flow when in operation;

FIG. 9 shows a schematic cross-sectional view of part of the duct system of FIG. 7, including directional arrows calculated by numerical analysis indicating the direction of flow when in operation;

FIG. 10 shows a schematic cross-sectional view of part of a duct system not including a guiding array, including directional arrows calculated by numerical analysis indicating the direction of flow when in operation;

FIG. 11 shows a schematic cross-sectional view of part of a duct system including a ‘diagonal’ guiding array embodiment, including directional arrows calculated by numerical analysis indicating the direction of flow when in operation; and

FIG. 12 shows a simulation calculated by numerical analysis of flow through the prior art guiding array of WO2015/052469.

### DETAILED DESCRIPTION

Regarding all of the data in Table 1, shown below, and all of the drawings of flow shown, the flow conditions were calculated using numerical simulations performed with Ansys Fluent in a 2D axisymmetric configuration with swirl, using the steady-state pressure-based solver assuming compressible flow. Turbulence was modelled using the k-omega SST closure. All simulations were performed using second order discretization for flow, energy, and turbulence variables, the PRESTO! pressure interpolation scheme and the SIMPLE algorithm for the pressure-velocity coupling. The mesh was refined in several stages to capture flow separation and (possible) recirculating zones accurately. The finest mesh contains an average of 150000 quadrilateral elements, with a maximum face size of 4 mm and a boundary layer with a first element thickness of 0.01 mm, and a growth rate of 1.2.

This set-up yields a y+ value less than 1 throughout the contour of the ducting, ensuring that flow separation is captured as accurately as possible.

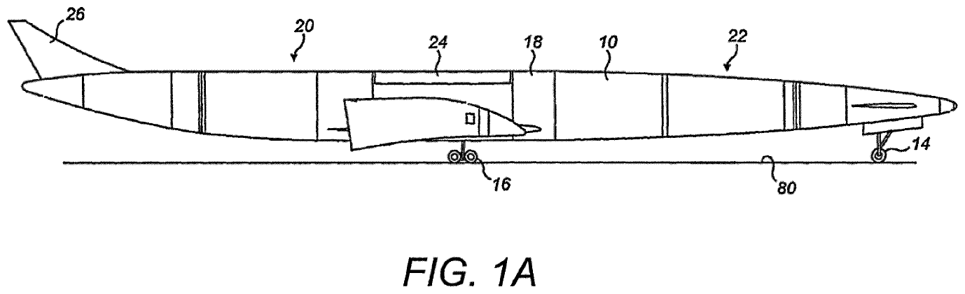

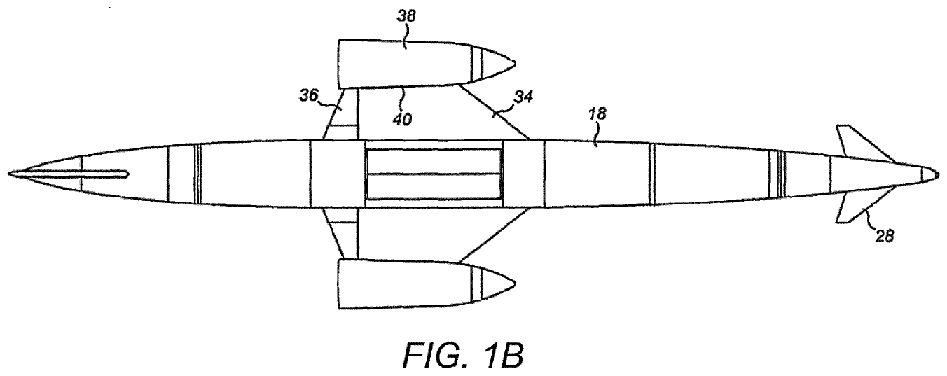

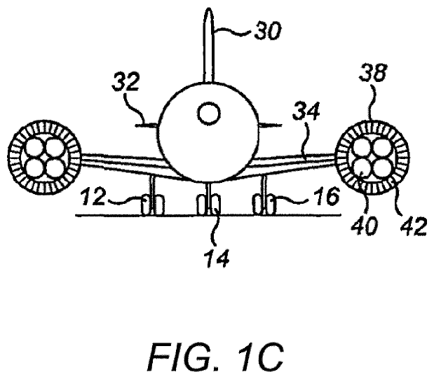

As shown in FIGS. 1A, 1B, and 1C, an aircraft 10 with a retractable undercarriage 12, 14, 16, has a fuselage 18 with fuel and oxidant stores 20, 22, and payload region 24. A moving tail fin arrangement 26 and a moving canard arrangement 28 are attached to the fuselage 18. Main wings 34 with elevons 36 are attached to either side of the fuselage 18, and each wing 34 has an engine module 38 attached to a wing tip 40 thereof. As show in FIG. 1C, a rear of each engine module 38 is provided with four rocket nozzles 40 surrounded by various optional bypass burners 42. There may be fewer than four rocket nozzles 40, such as one or two, or there may be more than four rocket nozzles, such as five or ten.

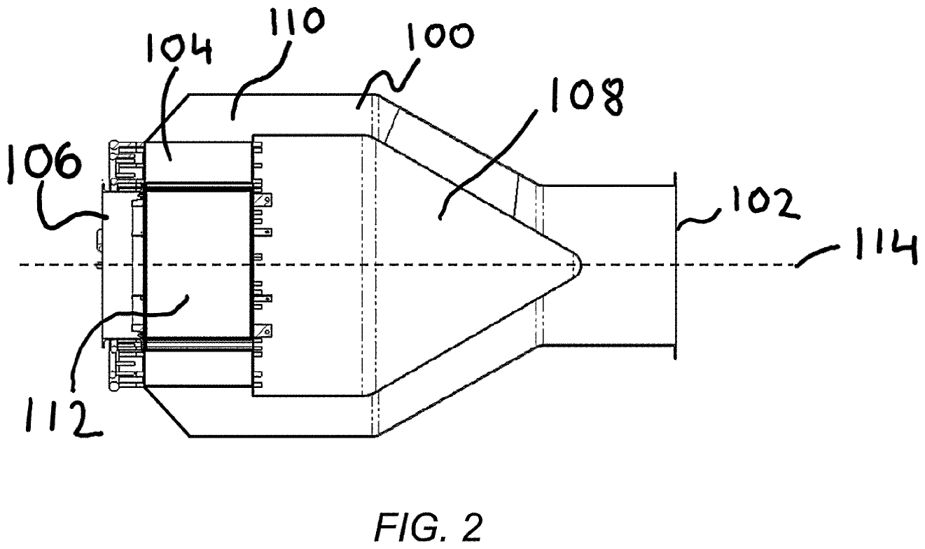

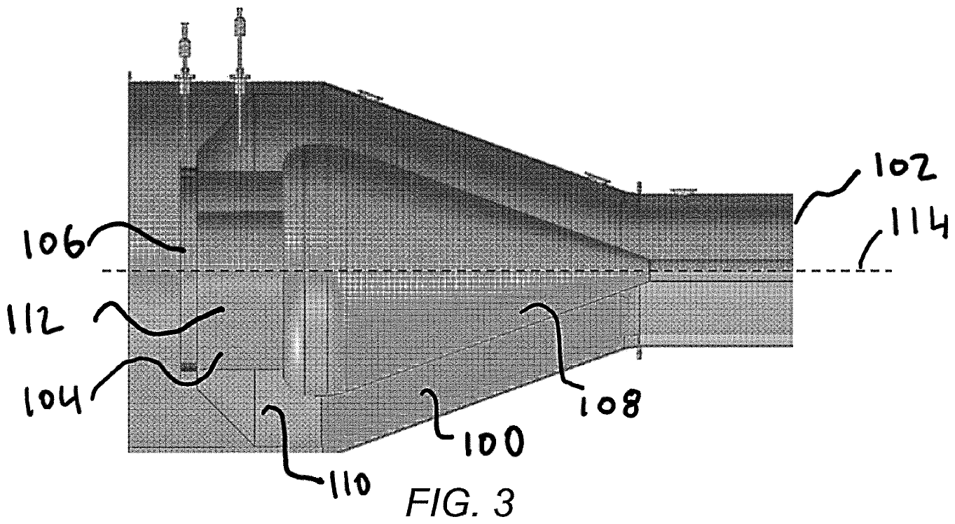

A flow duct system 100 used in each engine module 38 can be seen in FIGS. 2 and 3 and includes an air inlet 102, a pre-cooler 104, and an outlet 106. A dashed line indicates a longitudinal axis 114 of the flow duct system 100. The air inlet 102 can be sited to accept atmospheric air entering the engine module 38. The outlet 106 leads towards downstream engine components (not shown) of the engine module 38 including combustion components (not shown) leading flow towards the rocket nozzles 40 and optional bypass burners 42.

The terms longitudinal and axial may be used interchangeably throughout this specification. Any radial direction is defined in relation to a longitudinal direction parallel with any longitudinal axis disclosed throughout this specification, for example the longitudinal axis 114 of the flow duct system 100.

In operation, flow coming from the air inlet 102 is diverted radially and slowed by a cone diffuser 108 into a setting chamber 110. Towards a downstream end of the setting chamber 110, the flow turns radially inwardly towards the pre-cooler 104 which may be a heat exchanger assembly. The heat exchanger assembly 104 may optionally use circulating helium to cool air and may be substantially as disclosed in WO2015/052469: thus, downstream, the air may be used in a combustion process as the course of oxidant. At a cylindrical pre-cooler outlet region 112, the flow turns back axially towards the outlet 106.

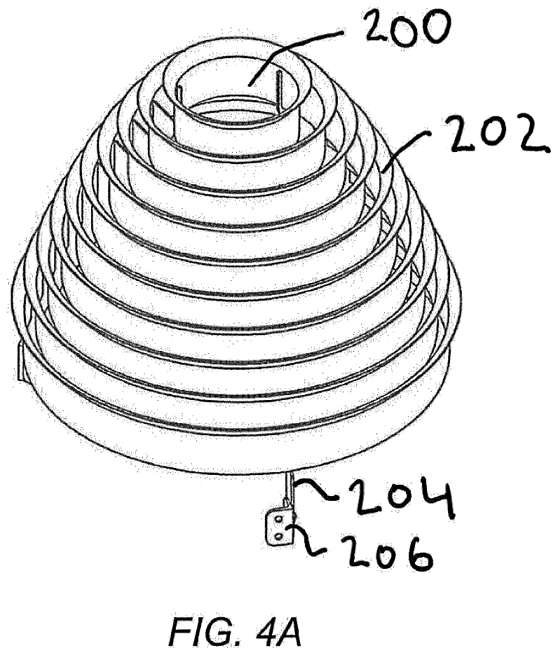

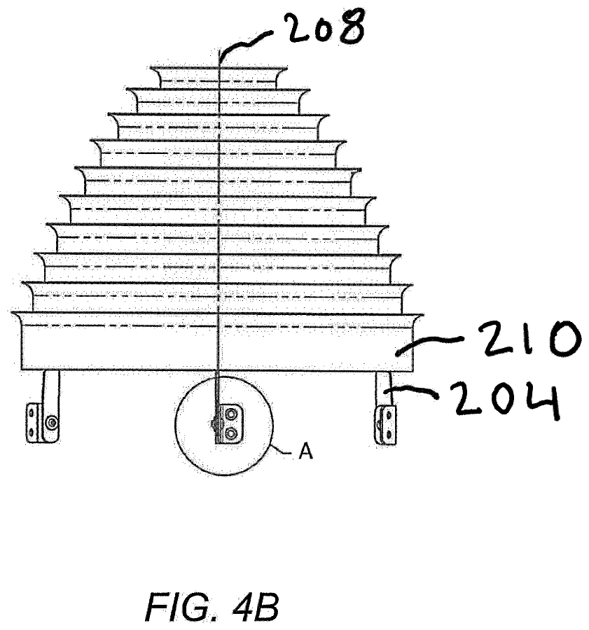

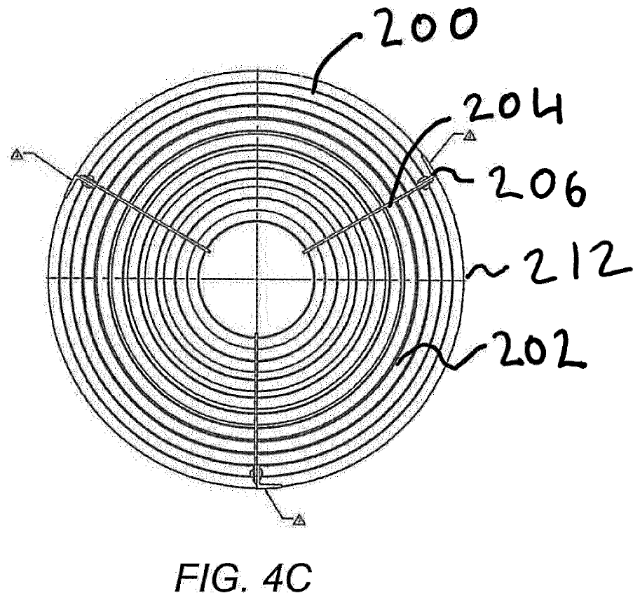

FIGS. 4A to 6C show a preferred example of a flight tube turning assembly (or guiding array) 200 which is situated within the pre-cooler outlet region 112.

The guiding array 200 includes a plurality of guide vanes 202. The dashed line seen on FIG. 4B indicates a central longitudinal axis 208 of the guiding array.

The guiding array 200 may include a series of guide vanes 202 arranged in a series of increasing length and/or diameter from one side of the guiding array 200 to another.

Each guide vane 202 may be annular, or ring-like. As seen in this embodiment, the annular or ring-like guide vanes 202 may be internested with one-another.

There may be provided between two and twenty, or between 8 and 16, guide vanes 202, or there may be more, such as fifty guide vanes. The embodiment shown in FIGS. 4A to 4C includes ten guide vanes.

The guide vanes 202 may be regularly spaced in the longitudinal and/or radial direction. The guide vanes 202 may also be spaced irregularly in the longitudinal and/or radial direction. For example, the guide vanes may be arranged such that their spacing increases or decreases as one goes from an edge of the guiding array 200 to its centre.

The guide vanes 202 may be of substantially uniform thickness. Alternatively, the thickness of some of the guide vanes 202 may vary. Guide vanes 202 may, for example, be between 0.5 and 5 mm thick. For example, the guide vanes 202 may be 1 mm thick each. The guide vanes 202 may, for example, be constructed by bending a plate and/or strip of material, or by other methods such as additive manufacturing.

The guide vanes 202 may be located in different radial positions, or may be spaced apart varying distances from the longitudinal axis 208 of the guiding array 200. This may mean that one guide vane 202 is located in a first distance from the longitudinal axis 208 of the guiding array 200 and another guide vane 202 is located a second distance from the longitudinal axis 208 of the guiding array 200, wherein the first and second distances are different.

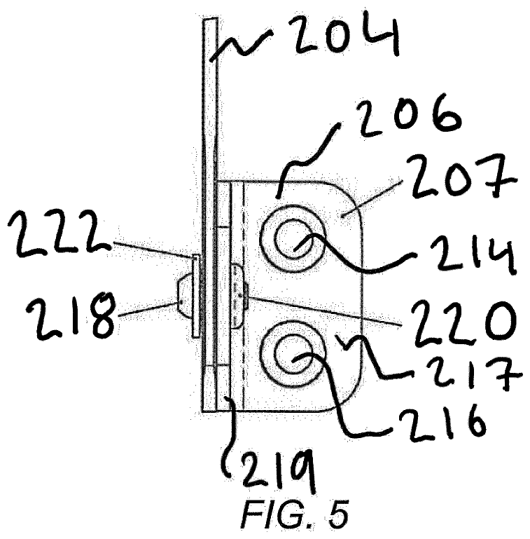

As seen in detail in FIG. 5, at least one bracket 206 may be included in the guiding array 200 for support thereof. The bracket 206 may also be referred to as a flight tube turning vane bracket, a flight tube turning vane bracket assembly, a guiding array bracket, a guiding array bracket assembly, or simply as a bracket assembly. The bracket 206 includes a bracket body 207, at least one fixing means 218, at least one threaded top hat 220, and at least one washer 222. At least one bracket 206 may be provided on a base portion 210 of the guiding array 200—see FIG. 4B. The base portion 210 may include a number of guide vanes 202, and may also include the bracket 206 and/or a step structure 204 described in more detail below. The guiding array 200 shown in FIGS. 4A to 4C includes three brackets 206. The bracket 206 in accordance with a preferred embodiment of the present invention is shown in more detail in FIG. 5.

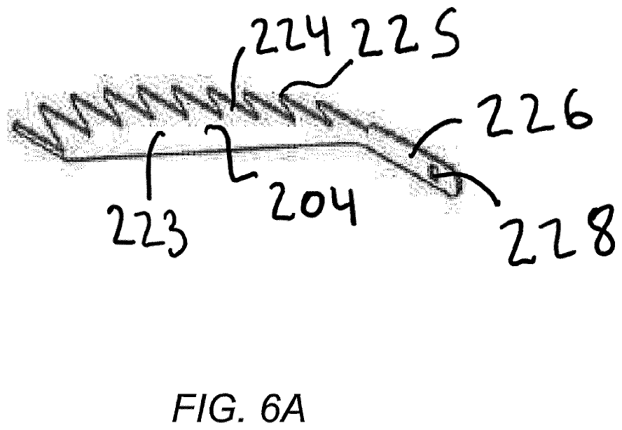

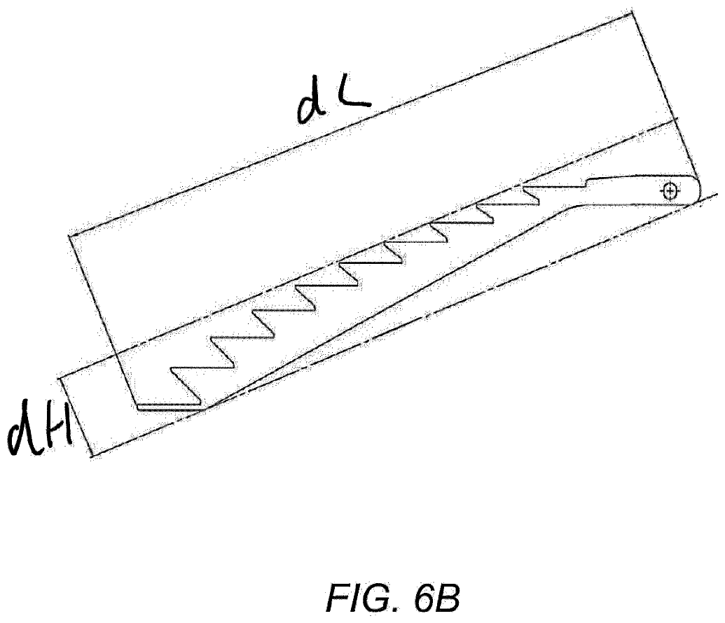

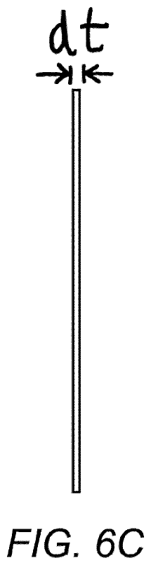

As seen in detail in FIGS. 6A to 6C, at least one step structure 204 may be included in the guiding array 200 for supporting the vanes 202. The step structure 204 may be referred to as a flight tube turning vane step, a guiding array step, or simply as a structural step. There may be provided at least one step or protrusion 225 in the step structure 204.

For example, there may be one step structure 204, there may be more than one step structures, and/or there may be five or more step structures 204. The guiding array 200 shown in FIGS. 4A to 4C includes three step structures 204. The step structures 204 provide structural support to guide vanes 202. Each step structure 204 may have a bracket 206 detachably or permanently attached thereto.

The bracket 206 may be provided for mounting said guiding array 200 within a duct. If there is more than one bracket 206, the brackets may be equidistantly spaced. The at least one bracket 206 may be arranged on an outer edge or a perimeter 212 of the guiding array 200.

A body 207 of the bracket 206 may be a plate bent at 90° degrees. The bracket body 207 may include at least one aperture 214, 216. The bracket 206 shown in FIG. 5 includes two apertures 214, 216 provided on a first portion and one aperture provided on a second portion 219.

The fixing means 218 is provided for detachably attaching the bracket 206 to one of the step structures 204. The fixing means 218 may comprise a bracket fixing means, a screw (in the present embodiment, an M6 button head screw), a bolt and/or adhesive. The fixing means 218 may be provided through an aperture provided on the second bracket portion 219.

As seen in FIGS. 6A to 6C, the step structure 204 may include a main portion 223. The main portion 223 is serrated. The main portion 223 includes at least one engagement means 224. The engagement means 224 may include at least one protrusion/step 225. The protrusion/step 225 of the engagement means 224 may comprise at least one tooth.

The step structure 204 is adapted for fixing onto the bracket 206. The step 204 structure includes an end portion 226 having an aperture 228. The aperture 228 is aligned with an aperture of the second portion 219 of the bracket 206 with the fixing means 218 being inserted therethrough. The step 204 is elongate. Varying spacing between each protrusion 225 of the step structure 204 result in variation in guide vane 202 spacing when said guide vanes 202 are inserted between said protrusions 225. The bracket 206 and/or the step structure 204 may be constructed of a metallic material, such as stainless steel, or a polymer material, such as plastic.

As shown in FIGS. 6B and 6C, the protrusions/steps 205 are of length dL in total, height dH, and thickness dT. Step length dL may optionally be between 1 and 1000 millimetres, such as about 500 millimetres. Step height dH may optionally be between 1 and 1000 millimetres, such as about 70 millimetres. Step thickness dt may optionally be between 0.01 and 100 millimetres, or between 1 and 5 millimetres.

The step may be manufactured using a sheet of thickness dt. The step 204 may be manufactured using 3D printing methods, also known as additive manufacturing methods.

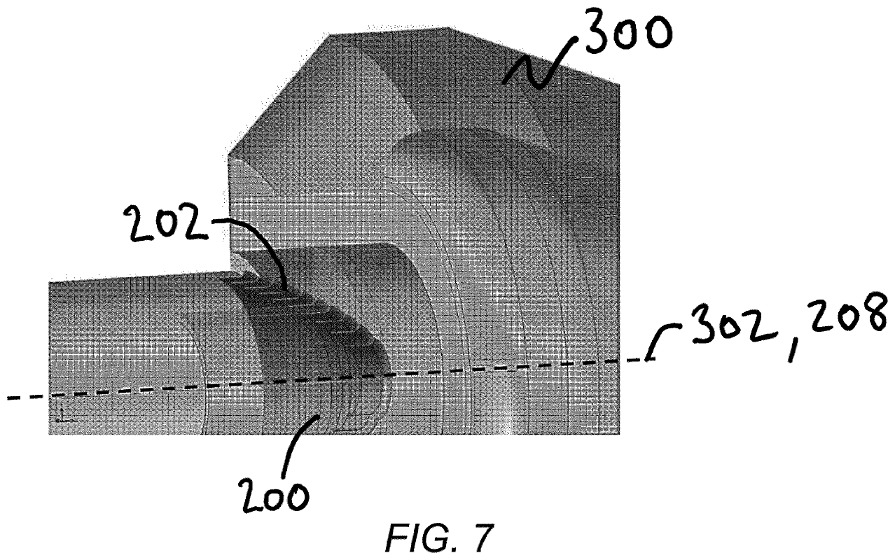

FIG. 7 shows a flow duct system 300 which may be interchangeable with or the same as flow duct system 100. The guiding array 200 is located within the flow duct system 300. The guiding array 200 includes the plurality of guide vanes 202. The longitudinal axis 302 of the flow duct system 300 is indicated by a dashed line. This coincides with the longitudinal axis 208 of the guiding array 200. This configuration of the flow duct system 300 is known as the ‘Mass Balanced Guide Vane’ configuration, or ‘MBGV’.

The guiding array 200 is adapted to divert flow from generally radial to generally longitudinal/axial, with either the central axes 302, 208 defining the longitudinal/axial direction. In other embodiments, the guiding array 200 may be adapted to divert flow from generally longitudinal to generally radial, from a direction with a longitudinal component to a direction with a radial component, and/or from a direction with a radial component to a direction with a longitudinal component.

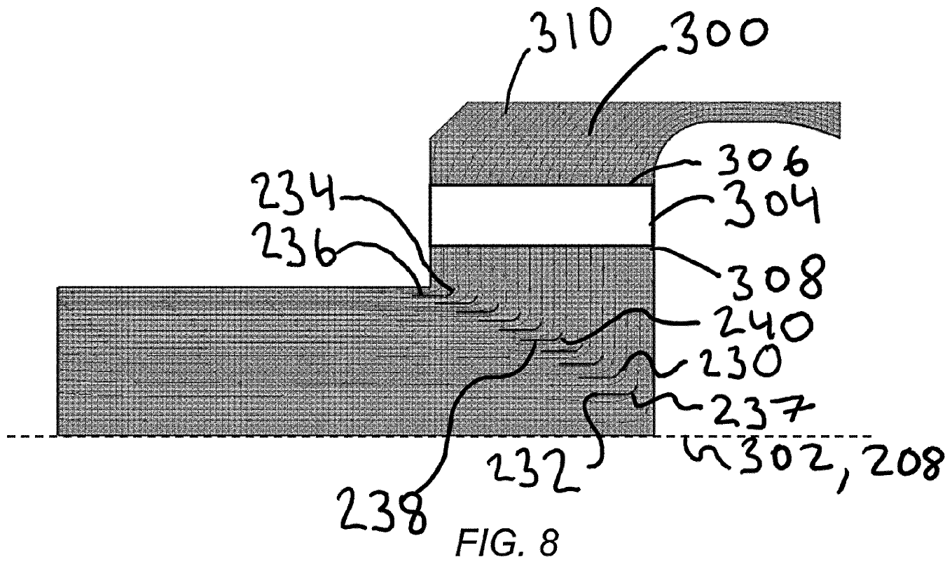

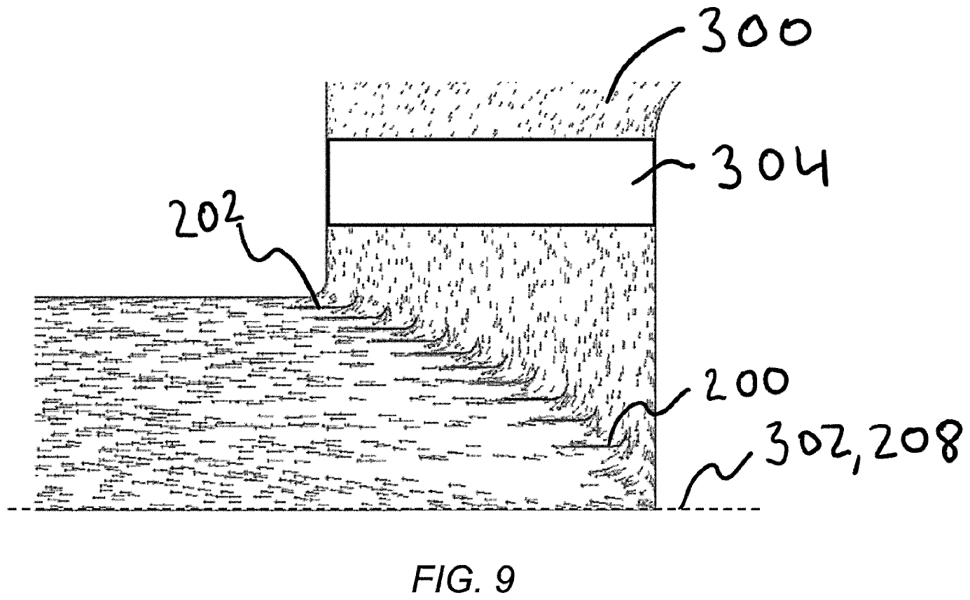

FIGS. 8 and 9 show a cross-section of guide vanes 202 located within the flow duct system 300. The flow duct system 300 further includes the pre-cooler 304/104 having a pre-cooler inlet 306 and a pre-cooler outlet 308.

Specific features of guide vanes 202 will now be discussed, which may apply to each guide vane included in the guiding array, or only to some of them. Unless stated otherwise, all features of guide vanes 202 discussed, such as various lengths and curves, may vary from an outer region of the guiding array 200 to an inner region of said guiding array 200.

The guide vanes 202 include a leading edge 230, and a trailing edge 232.

The leading edge of at least one guide vane 202 may be arranged at an angle of about −5 to 10, or about 2 to 5 degrees relative to the longitudinal/axial axis 208 of the guiding array 200 and/or the longitudinal/axial axis 302 of the flow duct system 300. Each guide vane 202 includes a leading section 234 and a trailing section 236. The leading section 234 is a portion of a guide vane 202 which includes its leading edge 230. Similarly, the trailing section 236 of a guide vane 202 is a portion of a guide vane 202 includes it trailing edge 232.

In this embodiment, the leading section 234 extends at least partly radially when seen in the section of FIG. 8, and the trailing section extends substantially longitudinally/axially, with either the longitudinal/axial axis 302 or the longitudinal/axial axis 208 defining the longitudinal/axial direction.

The lengths of leading and trailing sections 234, 236 of one said guide vane 202 may vary or may not vary when compared with other guide vanes.

In this embodiment, each guide vane 202 includes a straight portion 238 and a curved portion 234. This may be seen in the cross-sections of FIG. 8 and FIG. 9. The guide vanes 202 include at least one straight portion 238 and at least one curved portion 240. If included, the length of the straight portion 238 may vary or may not vary, as may the length of the curved portion 240, between the guide vanes 202.

Guide vanes 202 may be distributed along a curve. Any portion of each guide vane, selected from but not limited to the following: the leading edge 230, the leading section 234, the trailing edge 232, the trailing section 236, or a point of maximum curvature 237, are distributed along a parabolic surface of revolution, in which the parabolic surface of revolution is

$$\frac{r ( x )}{R} = \sqrt{\frac{x}{L}}$$

where r(x) is the radial location of the leading edge (or other common part of) of each guide vane, as a function of its axial coordinate x, R is the radius of an axial flow duct into or from which the array communicates, and is an axial length of a radial flow duct from or into which the array communicates.

The leading section 234 of each guide vane 202 is flared. Thus, the leading section 234 of each guide vane 202 extends outwards so as to be radial or substantially radial. As the leading section 234 is curved to create the flared portion, it may be said to be curvedly-flared. In other embodiments, the leading section may not be flared, for example extending inwards radially, and/or may not be curvedly-flared, for example including a sharp bend discontinuity with no discernible curve.

The leading and/or trailing sections 234, 236 of each guide vane 202 may form part of a substantially cylindrical surface. This may include an entire curved surface of a cylinder, or only part of it. Similarly, the leading and/or trailing sections 234, 236 of each guide vane 202 may form part of a frustum surface. This may include an entire surface, which may be curved, of a frustum, or only part of it.

The ratio of cross-sectional area form between the leading sections 234 of two adjacent guide vanes 202 to cross-sectional area formed between the trailing sections 236 of said two adjacent guide vanes 202 may be substantially equal for a majority of, or all, adjacent guide vanes 202. Said ratio may be greater than one, wherein the cross-sectional area formed between leading sections may be greater than the cross-sectional area formed between trailing sections 236, or may be less than one, wherein the cross-sectional area formed between trailing sections 236 may be greater than the cross-sectional area formed between leading sections 234.

Streamlines 310 calculated by numerical analysis can be seen in FIG. 8 which indicate flow direction when the flow duct system 300 is in operation. A streamtube is a tubular region of fluid bounded by streamlines. A streamtube is formed between each two adjacent guide vanes 202. A mass flow rate of each streamtube formed between consecutive guide vanes may be roughly equal to one another. As such, an inlet to outlet cross-sectional area ratio, between each two adjacent guide vanes 202, which may be the ratio of the distance between guide vane leading edges 230 and the distance between guide vane trailing edges 232, may be substantially equal to one another for all of the streamtubes.

FIG. 9 shows arrows which indicate the local direction of flow when the flow duct system 300 is in operation. As can be seen, upstream flow is substantially radial until very close to the vanes 202 and downstream flow is substantially axial from very close to the vanes 202.

The guide vanes 200 are passive. This may mean that the guide vanes 202 are not connected to any actuation means such as a motor, but they could be in other embodiments, in which the position of the guide vanes 202 relative to the longitudinal axis 208 of the guiding array 200 and/or the longitudinal axis 302 of the flow duct system 300 may vary during operation. In the present embodiment, however, the positions of the guide vanes 202 within the guiding array 200 does not vary.

The guiding array 200, or its constituent parts the guide vanes 202 and/or the step 204 and/or the bracket 206, may all be formed of the same material, or they may be formed of different materials. These materials may include metallic materials, such as stainless steel and/or superalloys, such as nickel-chromium-iron-molybdenum or nickel-chromium based superalloys, and/or polymer materials, such as plastic.

As will be appreciated by those skilled in the art, the guiding array 200 and/or each of its components, can be produced via additive manufacturing, for example via the use of a 3D printer. First, a computer-readable file containing data representative of a guiding array 200 or any of its components is produced. The data may be representative of their geometry of success cross-sections of the guiding array 200 and/or any of its components. This data is often called ‘slice’ and/or ‘layer’ data. The data can be produced from a computer aided design CAD file, or via the use of a 3D scanner. The 3D printer can then successively lay down layers of material in accordance with the cross-section data to produce the guiding array as an integral part, or any of the components of the guiding array 200.

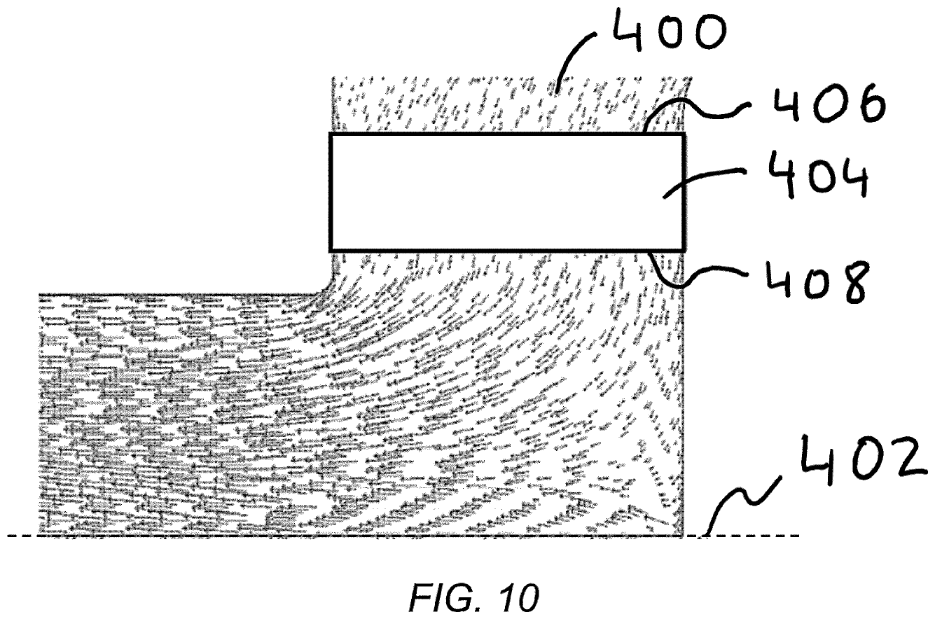

FIG. 10 shows a flow duct system 400 which may be interchangeable with flow duct system 100, and is included for purposes of comparison with the invention. Unlike flow duct system 100, there is no guiding array located within the flow duct system 400. The longitudinal axis 402 of the flow duct system 400 is indicated by a dashed line. The flow duct system 400 further includes a pre-cooler 404 the same as that of the earlier figures and having a pre-cooler inlet 406 and a pre-cooler outlet 408. This configuration of the flow duct system 400 is known as the ‘No Guide Vane’ configuration, or ‘NGV’.

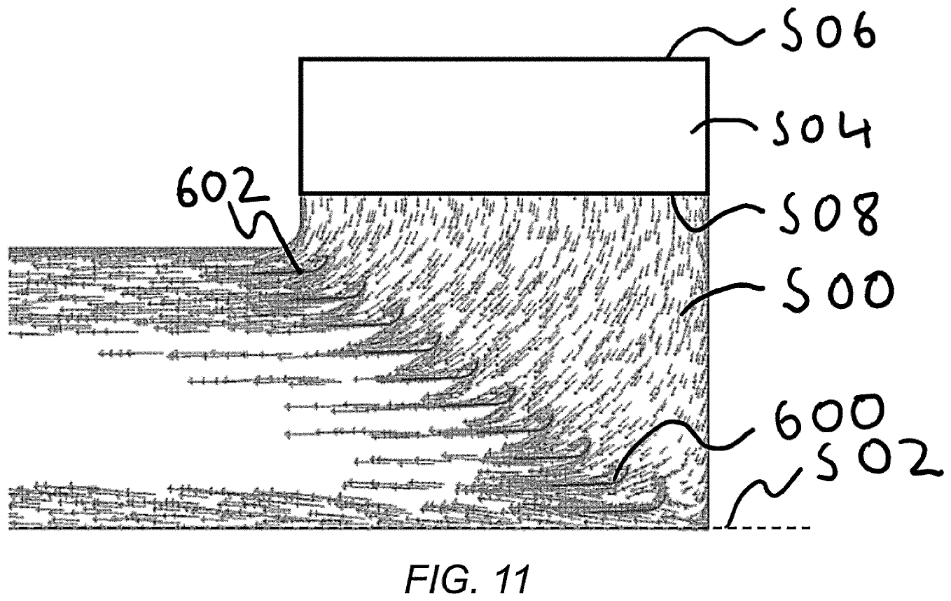

FIG. 11 shows a flow duct system 500 which may be interchangeable with flow duct system 100. The guiding array 600 is located within the flow duct system 500. The guiding array 600 includes a plurality of guide vanes 602. The plurality of guide vanes 602 are the same as the plurality of guide vanes 202 but are configured in a regularly spaced diagonal array when seen in cross section as in FIG. 11. The longitudinal axis 502 of the flow duct system 500 is indicated by a dashed line. The flow duct system 500 further includes a pre-cooler 504 identical to that of the earlier figures and having a pre-cooler inlet 506 and a pre-cooler outlet 508. This configuration of the flow duct system 500 is known as the ‘Diagonal Guide Vane’ configuration, or ‘DGV’.

A comparison will now be made between the NGV configuration of FIG. 10, the DGV configuration of FIG. 11, and the MBGV configuration seen in FIG. 9.

If flow upstream of the longitudinal duct section is uneven, some areas of pre-coolers 304, 404, 504 may reach maximum operating temperature before others. This would clearly lead to inefficiencies. For both NGV and DGV configurations, the flow direction, indicated by the direction of the arrows, can be seen to begin turning longitudinally very soon after passing through the respective pre-cooler outlet 408, 508. In contrast FIG. 9 shows that the MBGV configuration very substantially reduces the amount of longitudinal turning of the flow upstream of the guiding array 200. This has the effect of ensuring flow through the pre-cooler 304 is consistent, improving the efficiency of pre-cooler 308 compared with pre-coolers 404, 504. Flow downstream of the array 200 is also relatively uniform.

Table 1, shown below, displays comparative metrics for three type of guiding array configurations at the outlet of the pre-cooler, the outlet essentially being a cylindrical surface in space immediately downstream of the heat exchanger in each case. In each case the mean and deviation (standard deviation) are calculated by observing the numerical data fully along the fully axial length of the heat exchange outlet.

TABLE 1

| | Radial | | Axial | | Static | |
|---|---|---|---|---|---|---|
| | velocity (m/s) | | velocity (m/s) | | Pressure (Pa) | |
| | Mean | Deviation | Mean | Deviation | Mean | Deviation |
| NGV | 24.80 | 1.30 | 1.43 | 0.93 | 102910 | 956 |
| DGV | 21.73 | 0.32 | 0.41 | 0.28 | 117000 | 254 |
| MBGV | 24.60 | 0.15 | 0.14 | 0.14 | 103170 | 78 |

Clearly, the deviation in radial velocity, axial velocity and static pressure of the DGV example (see FIG. 11) is superior to that of the NGV example (see FIG. 10). Even though the DGV array of FIG. 11 looks very similar to the MBGV array (see FIGS. 8 and 9), the performance of the MBGV array is very surprisingly far superior in all respects. Therefore the MBGV array disturbs upstream flow through the heat exchanger far less than the DGV and NGV arrangements.

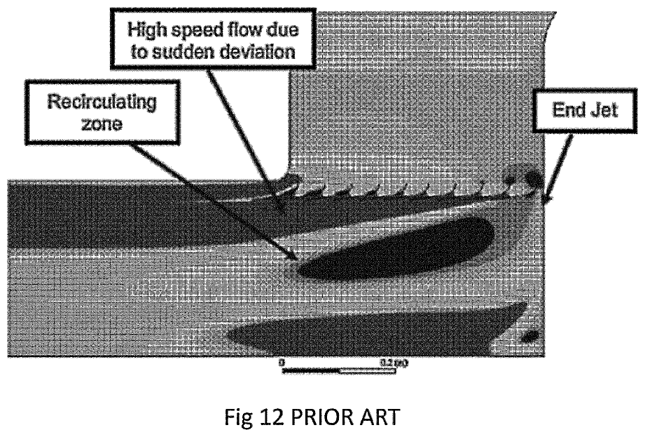

FIG. 12 shows numerical analysis of flow in the prior art arrangement of WO2015/052469, the depth of shading depicting different flow velocities. Clearly, there is a very high speed zone in the radially outer half of the axial exit duct, together with a significant recirculating zone. Performance is clearly such that flow upstream of the array is badly affected and performance is significantly worse that the DGV and MBGV arrangements in which there is clearly no recirculation zone as indicated by the flow arrows in FIGS. 8, 9 and 11. Clearly the DGV and MBGV arrangements are both significant improvements over the prior art arrangement, the MBGV being vastly improved.

Various modifications may be made to the described embodiments without departing from the scope of the invention as defined by the accompanying claims.

1. A guiding array for turning flow in a fluid handling system, the guiding array comprising a plurality of guide vanes, common parts of the guide vanes being arranged to be positioned different distances from an upstream port within a fluid handling system.

2. A guiding array as claimed in claim 1 which is arranged to be positioned within a fluid handling system for turning flow from one of substantially radial and substantially axial to the other of substantially radial and substantially axial.

3. A guiding array as claimed in claim 2 which is arranged to be positioned within a fluid handling system for turning flow from substantially radially inward to substantially axial.

4. A guiding array as claimed in claim 1 in which at least one vane of the array comprising a circular or substantially circular ring.

5. A guiding array as claimed in claim 4 in which each vane comprises a circular or substantially circular ring, the vanes being concentric about a central longitudinal axis of the array.

6. A guiding array as claimed in claim 5 in which the vanes are arranged with larger cross-dimension (or diameter) towards one end of the array.

7. A guiding array as claimed in claim 6 which is for turning flow at a flow bend from substantially radially inward flow to substantially axial flow, the end of the array having a vane with a larger cross-dimension (or diameter) being arranged for positioning adjacent an inner side of the flow bend, another end of the array having a vane with a smaller dimension being arranged for positioning at an outer side of the flow bend.

8. A guiding array as claimed in claim 1 in which the common parts are leading edges of the vanes.

9. A guiding array as claimed in claim 8 in which the leading edges are arranged at points in space that are located on an imaginary conic surface.

10. A guiding array as claimed in claim 8 in which the leading edges are arranged at points in space that are located (a) irregularly spaced apart from one another in radial and/or axial directions relative to a central longitudinal axis of the array and/or (b) on an imaginary parabolic surface of revolution around a central longitudinal axis of the array.

11. A guiding array as claimed in claim 10 in which the parabolic surface of revolution is
$$\frac{r ( x )}{R} = \sqrt{\frac{x}{L}}$$
where r(x) is the radial location of the leading edge of the guide vane, as a function of its axial coordinate x, R is the radius of an axial flow duct into or from which the array communicates, and L is an axial length of a radial flow duct from or into which the array communicates.

12. A guiding array as claimed in claim 1 in which the vanes in the array are configured generally in a skep beehive-shaped fashion.

13. A guiding array as claimed in claim 1 in which each vane, in a cross section thereof by a plane coincident with a central longitudinal axis of the array, includes a curved region between a leading edge and a trailing edge thereof.

14. A guiding array as claimed in claim 13 in which each said cross section of each vane is substantially identical to the said cross section of another vane or all vanes in the array.

15. A guiding array as claimed in claim 1 in which, other than any streamlining curvature at a leading edge and/or a trailing edge thereof, a vane as a substantially constant thickness between a leading edge and a trailing edge thereof.

16. A guiding array as claimed in claim 1 in which vanes of the array are internested with one another, at least in a sense that in a section taken perpendicular to a central longitudinal axis of the array a leading or trailing edge of one vane is overlapped with an adjacent vane.

17. A guiding array as claimed in claim 1 in which each vane has a leading edge and a trailing edge, and in which a ratio I1-2/O1-2 (between an inlet area I1-2 defined between the leading edges of a first and a second adjacent vane and an outlet area O1-2 defined between the training edges of the first and the second vane) is equal or substantially equal to the ratio I2-3/O2-3 (between an inlet area I1-2 defined between the leading edges of the second and a third adjacent vane and an outlet area O1-2 defined between the training edges of the second and the third vane.

18. A guiding array as claimed in claim 17 in which the ratio I1-2/O1-2 equals or substantially equals the equivalent ratio In−(n+1)/On−(n+1) between any adjacent two vanes in the array.

19. A guiding array as claimed in claim 1 in which the upstream port is defined by an imaginary cylindrical surface in space.

20. A guiding array for a fluid handling unit comprising a plurality of guide vanes for turning flow, wherein the plurality of guide vanes are spaced varying distances apart.

21. A ducting system including a first duct portion arranged to carry a substantially radial flow communicating via a bend with a second adjacent duct portion arranged to carry a substantially axial flow, a guiding array as claimed in claim 20 being located in the region of the bend for turning flow passing between the duct portions.

22. A ducting system as claimed in claim 21 in which the first duct portion is located in a location upstream (in use) of the second duct portion.

23. A ducting system as claimed in claim 21 in which the first duct portion contains a heat exchanger, the heat exchanger being adapted to receive substantially radial flow from within the first duct portion into an inlet of the heat exchanger and to provide a substantially radial flow back into the first duct portion at an outlet from the heat exchanger.

24. A ducting system as claimed in claim 23 in which the outlet from the heat exchanger is substantially at an imaginary cylindrical surface in space which coincides with an upstream port for the guiding array.

25. A ducting system as claimed in claim 23 in which the first duct portion is configured in materials arranged to operate continuously handling air with a static temperature of at least 900 degrees C.

26. A ducting system as claimed in claim 21 in which the second duct portion has a substantially cylindrical outer wall portion.

27. A ducting system as claimed in claim 21 which includes a substantially circular substantially flat end plate portion perpendicular to and concentric with a central longitudinal axis of the guiding array, the end plate forming an extension to a radial wall defining the first duct portion as well as facing the second duct portion.

28. An engine including a ducting system as claimed in claim 21.

29.-35. (canceled)
